(19) United States
(12) Patent Application Publication
(10) Pub. No.: US 2008/0206399 A1
(43) Pub. Date: Aug. 28, 2008

(54) Method and Use of a Laccase Enzyme in a Baked Product

(76) Inventors: Hans Peter Heldt-Hansen, Virum (DK); Todd Forman, Raleigh, NC (US); Frank T. Rittig, Binningen (CH)

Correspondence Address: NOVOZYMES NORTH AMERICA, INC., 500 FIFTH AVENUE, SUITE 1600, NEW YORK, NY, 10110, US

(21) Appl. No.: 11/916,763

(22) PCT Filed: Jun. 13, 2006
(86) PCT No.: PCT/US06/22976

§ 371 Date: Feb. 20, 2008

Related U.S. Application Data
(60) Provisional application No. 60/691,218, filed on Jun. 16, 2005.

(51) Int. Cl. A21D 8/04

(52) U.S. Cl. 426/18

(57) ABSTRACT

The present invention relates to a method of preparing a baked product from dried masa flour, wherein an enzyme capable of polymerizing polyphenolics is added to the dough, as well as to a use of such an enzyme in a baked product made from non-leavened dough comprising dried masa flour.

### FIELD OF THE INVENTION

The present invention relates to a method of preparing a baked product from dried masa flour, to a use of an enzyme capable of polymerizing polyphenolics in the production of a baked product, and to a corn tortilla obtainable by the method of the invention.

### BACKGROUND OF THE INVENTION

In the bread-making process it is known to add bread-improving and/or dough-improving additives to the bread dough, the action of which, inter alia, results in improved texture, volume, flavour and freshness of the bread as well as improved machinability of the dough.

In recent years a number of enzymes have been used as dough and/or bread improving agents, in particular enzymes which act on components present in large amounts in the dough. Examples of such enzymes are found within the groups of amylases, proteases and cellulases, including pentosanases.

Some baked products, like corn tortillas, are however made from non-leavened dough and therefore loaf volume, crumb structure, dough strength etc. are not relevant attributes in corn tortillas.

Corn tortillas are made from corn cooked in alkali and rinsed in a process called nixtamilization. The corn is then ground to a course paste and the resulting dough is called nixtamal or masa.

Tortillas can be made from fresh nixtamal or very often from dried nixtamal, wherein the nixtamal has been dried down to course flour like consistency. Tortillas made from fresh nixtamal have good resistance and consequently can be crumbled in the hand and will not fall apart when unfolded. They also have good flexibility (stretchability). When tortillas are made from dried nixtamal (masa flour) the resistance and flexibility characteristics are lost. For this reason hydrocolloids such as carboxy methyl cellulose (CMC) or guar gum are added to masa flour for restoring these characteristics.

It is therefore desirable to have alternative ingredients to CMC or guar gum that can provide the above mentioned functionality.

It is the object of the present invention to provide such alternatives.

### SUMMARY OF THE INVENTION

The invention provides in a first aspect a method of preparing a baked product from dried masa flour, wherein an enzyme capable of polymerizing polyphenolics is added to the dough.

In a second aspect the invention provides a use of an enzyme capable of polymerizing polyphenolics in the production of a baked product made from dough comprising dried masa flour.

In a third aspect the invention relates to a corn tortilla obtainable by the method according to the invention.

### DETAILED DESCRIPTION OF THE INVENTION

Baked products made from unleavened dough based on nixtamilized corn lack some of the desirable characteristics of similar products made from fresh dough. This is the case when making tortillas from dried masa flour. In order to improve resistance and/or flexibility to the baked product normally hydrocolloids such as carboxy methyl cellulose (CMC) or guar gum are added. According to the present invention an alternative solution is the addition of an enzyme capable of polymerizing polyphenolics.

In the present invention “addition of an enzyme capable of polymerizing polyphenolics” means that an amount effective to improve resistance and/or flexibility of the dough based product prepared from the treated dough is added.

Thus the present invention is directed to the use of an enzyme having polyphenolic polymerizing activity. The enzyme is added in an amount effective to improve resistance and/or flexibility of the dough based product prepared from the treated dough.

In the present inventions enzymes capable of polymerizing polyphenolics include enzymes selected from the group consisting of laccase (EC 1.10.3.2), catechol oxidase (EC 1.10.3.1), rifamycin-B oxidase (EC 1.10.3.6), peroxidase (EC 1.11.1.7).

In a particular embodiment the enzyme is a laccase enzyme.

Laccase (EC 1.10.3.2) is an enzyme catalyzing the conversion of benzenediols into benzosemiquinones according to the following formula:

4 benzenediol+O₂=4 benzosemiquinone+2H₂O.

The enzyme has been used in the paper and pulp industry as well as for diagnosis, and the use of the enzyme in baking has been described in WO94/28728, in which a laccase is added to dough resulting in an increased volume and improved crumb structure and softness of the baked product. The dough according to WO94/28728 is a leavened dough or a dough to be subjected to leavening.

Catechol oxidase (EC 1.10.3.1) is an enzyme catalyzing the conversion of catechol to 1,2-benzoquinone according to the following formula:

2 catechol+O₂=2 1,2-benzoquinone+2 H₂O.

The enzyme is also known as diphenol oxidase and polyphenol oxidase.

Rifamycin-B oxidase (EC 1.10.3.6) is an enzyme catalyzing the conversion of rifamycin B to rifamycin O according to the following formula:

Rifamycin B+O₂=rifamycin O+H₂O₂.

Peroxidase (EC 1.11.1.7) is an enzyme catalysing the conversion of a donor substrate to an oxidized doner according to the following formula:

Donor+H₂O₂=oxidized donor+2H₂O.

The enzyme is also known as thiocyanate peroxidase and horseradish peroxidase.

The improvement in resistance and/or flexibility obtained according to the present invention can be determined using simple tests as described in the accompanying examples.

In one particular embodiment of the invention the nixtamilized corn is in the form of dried masa flour.

In another particular embodiment of the invention no hydrocolloid is added. Said hydrocolloid comprises CMC and guar gum.

The addition of an enzyme capable of polymerizing polyphenolics is particularly advantageous in connection with unleavened/non-leavened dough, such as e.g. tortilla dough. Particularly the enzyme is a laccase.

Thus in a particular embodiment the baked product is a tortilla. The tortillas made according to the method of the invention may in a subsequent step be used for making chips, i.e. the tortilla may be fried.

While the laccase enzyme may be of any origin, including plant origin, it is presently preferred that the laccase enzyme is of microbial origin. Thus, a microbial enzyme is normally easier to produce on a large scale than a non-microbial enzyme of, e.g., plant origin. Furthermore, the microbial enzyme may normally be obtained in a higher purity than enzymes of other origins, resulting in a lower amount of undesirable enzymatic side-activities.

The microbial laccase enzyme may be derived from bacteria or fungi (including filamentous fungi and yeasts) and suitable examples include a laccase derivable from a strain of Aspergillus, Neurospora, e.g. N. crassa Podospora, Botrytis, Collybia, Fomes, Lentinus, Lentinus, Pleurotus, Trametes, Rhizoctonia, e.g. R. solani, Coprinus, e.g. C. plicatilis, Psatyrella, Myceliophtera, e.g. M. thermophila, Schytalidium, Polyporus, e.g. P. pinsitus, Phlebia, e.g. P. radita (WO 92/01046), or Coriolus, e.g. C.hirsutus (JP 2-238885).

The laccase may be obtained from the microorganism in question by use of any suitable technique. For instance, a laccase preparation may be obtained by fermentation of a microorganism and subsequent isolation of a laccase containing preparation from the resulting fermented broth or microorganism by methods known in the art, but more preferably by use of recombinant DNA techniques as known in the art. Such method normally comprises cultivation of a host cell transformed with a recombinant DNA vector capable of expressing and carrying a DNA sequence encoding the laccase in question, in a culture medium under conditions permitting the expression of the enzyme and recovering the enzyme from the culture.

The DNA sequence may be of genomic, cDNA or synthetic origin or any mixture of these, and may be isolated or synthesized in accordance with methods known in the art.

The laccase enzyme to be included in the dough may be in any form suited for the use in question, e.g. in the form of a dry powder or granulate, in particular a non-dusting granulate, a liquid, in particular a stabilized liquid, or a protected enzyme. Granulates may be produced, e.g. as disclosed in U.S. Pat. No. 4,106,991 and U.S. Pat. No. 4,661,452 (both to Novo Industri A/S), and may optionally be coated by methods known in the art. Liquid enzyme preparations may, for instance, be stabilized by adding nutritionally acceptable stabilizers such as a sugar, a sugar alcohol or another polyol, lactic acid or another organic acid according to established methods. Protected enzymes may be prepared according to the method disclosed in EP 238,216.

Normally, for inclusion in pre-mixes or flour it is advantageous that the laccase enzyme preparation is in the form of a dry product, e.g. a non-dusting granulate, whereas for inclusion together with a liquid it is advantageously in a liquid form.

The dosage of the laccase enzyme to be used in the method of the present invention should be adapted to the nature and composition of the dough in question. Normally, the enzyme preparation is added in an amount corresponding to 10-500 Laccase Units per kg. masa flour. The Laccase Units (LAMU) may be determined by the assay described below in the Materials and Methods section.

In a particular embodiment the laccase enzyme is added in an amount of 10-500 LAMU/kg masa flour, particularly from 20-200 LAMU/kg masa flour, more particularly from 30-100 LAMU/kg masa flour.

When one or more additional enzyme activities are to be added in accordance with the method of the invention, these activities may be added separately or together with the laccase preparation.

In a particular embodiment the additional enzyme comprises hemicellulase.

As mentioned above the laccase enzyme is added to any mixture of dough ingredients, to the dough, or to any of the ingredients to be included in the dough, in other words the laccase enzyme may be added in any step of the dough preparation and may be added in one, two or more steps, where appropriate. However, the enzyme should not be added together with any strong chemical or under conditions where the enzyme is inactivated.

The handling of the dough and/or baking is performed in any suitable manner for the dough and/or baked product in question, typically including the steps of mixing the dough, subjecting the dough to one or more proofing treatments, and baking the product under suitable conditions, i.e. at a suitable temperature and for a sufficient period of time.

### EXAMPLES

### Materials and Methods

### Enzymes

### Laccase:

The Laccase used was developed for brewing and also known as Flavourstar. However any source of laccase is applicable.

Other possible sources of laccase are given below:

A Rhizoctonia solani laccase produced by the Rhizoctonia solani strain RS22 deposited with the International Mycological Institute, Genetic Resource Reference Collection, located at Bakeham Lane, Egham Surrey TW20 9TY on Sep. 3, 1993 under the terms of the Budapest Treaty and given the accession number IMI CC 358730. The Rhizoctonia solani laccase is further described in co-pending application U.S. 5480801A1, the contents of which is hereby incorporated by reference.

Determination of laccase activity

Laccase activity is determined by incubating a laccase containing sample with syringaldazin (1 μmol syringaldazine) under aerobic conditions (30° C., 110 sec., pH 7.5), whereby the syringaldazin is oxidized to tetramethoxy azo bis-methylene quinone. The absorbance is measured at 540 nm, measuring time is 50 seconds.

1 Laccase Unit (LAMU) is the amount of enzyme which, under the prescribed reaction conditions, converts 1 μmol syringaldazin per minute.

### Example 1

### Lab-Scale Evaluation of Laccase as a Replacement for CMC in Corn Tortillas

Tortillas with 0.25% carboxy methyl cellulase (CMC) were used as a reference. The masa flour was fortified with vitamins and is the type used for home preparation. Corn white fiber was well-rinsed to remove SO₂ residue, dried at 115° C. for four hours and finely ground.

The Laccase used was developed for brewing and also known as Flavourstar (available from Novozymes, Bagsvaerd, Denmark). The activity was 830 LAMU/g.

1 laccase unit (LAMU) is the amount of enzyme needed to convert 1 μmol syringaldazine per minute under the analytical conditions given below.

Reaction conditions:

| Temperature | 30° | C. |
|---|---|---|
| pH | 7.5 | |
| wave length | 540 | nm |
| reaction time | 110 | seconds |
| measuring time | 50 | seconds |
| enzyme concentration | 0.0117-0.0350 | LAMU/ml |

The reaction is performed under aerobic conditions where laccase catalyses the oxidation of syringaldazine under formation of quinone.

The formation of the reaction product was measured using a Konelab 30 Analyzer (Thermo Clinical Labsystems)

Dough ingredients
250 g masa flour
312 g of H₂O
2.5 g guar (1% weight of masa)
   Dough mixing

The dough was mixed for 2 minutes at medium speed in a Kitchen-aid mixer using the paddle attachment. The dough was allowed to rest for 5 minutes (as per package directions) in a plastic bag and then divided into 40 g pieces. The dough pieces were rounded into a ball and pressed four times in a manual tortilla press, rotating the flattened disc a quarter of a turn after each press. The elapsed time from the beginning of dough division and the end of pressing was approximately 25 minutes.

The tortillas were cooked in a cast iron frying pan over high heat for a total of 45 seconds (15 seconds side A, 15 seconds side B, 15 seconds side A again). Tortillas were cooled on rack and packaged in plastic bags. Tortillas were evaluated the following day. Strength/flexibility was determined by grasping the tortilla by its edge and shaking it.

### Results

The trials were conducted in 3 parts.

TABLE 1
Trial set 1

| | % CMC | Flavourstar (LAMU/kg masa) |
|---|---|---|
| V1 | 0.25 | — |
| V2 | — | — |
| V3 | — | 83 |
| V4 | — | 830 |

TABLE 2
Dough Evaluation, set 1

| | After mixing | After resting |
|---|---|---|
| V1 | tacky | slightly less tacky; cohesive |
| V2 | less tacky than V1 | softer than V1 |
| V3 | similar to V2 | similar to V1, a bit more crumbly |
| V4 | similar to V1 | Ok, similar to V1 |

### Tortilla Evaluation

V3, V4 a shade darker than V1, V2. No difference between V3 and V4;
Very subtle differences between V1 and V2. All were rubbery; V2 a little more flexible (floppier when shaken);
V2 had the best eating quality; V1, V3 and V4 seemed very rubbery;

TABLE 3
Trial set 2

| | % CMC | Flavourstar (LAMU/kg masa) |
|---|---|---|
| V1 | 0.25 | — |
| V2 | — | 8.3 |
| V3 | — | 41.5 |
| V4 | — | 83 |

TABLE 4
Tortilla Evaluation

| | After mixing | After resting |
|---|---|---|
| V1 | tacky | less tacky, clay like |
| V2 | slightly less tacky than V1 | slightly tackier and softer than V1 |
| V3 | similar to V1 | similar to V1, not as soft as V1 |
| V4 | similar to V1 | stiffer dough than V1 |

### Tortilla Evaluation

V2-V4 did not puff up as much as V1 while cooking.
Very little to no color difference between V1 and 83 LAMU/kg masa as there was in set 1
All levels seemed at least equal to reference as far as strength
83 LAMU/kg masa seemed stiffer and firmer than the reference, perhaps too firm.

TABLE 5
Trial Set 3

| | % CMC | Flavourstar (LAMU/kg masa) |
|---|---|---|
| V1 | 0.25 | — |
| V2 | — | — |
| V3 | — | 41.5 |

TABLE 6
Tortilla Evaluation

| | After mixing | After resting |
|---|---|---|
| V1 | tacky, stiff dough | slightly less tacky, clay like |
| V2 | tacky | less tacky, softer than V1 |
| V3 | slightly less tacky, softer than | less tacky, stiffer than V2, |
| | V1 | perhaps not as stiff as V1 |

### Tortilla Evaluation

V2 slightly floppier than the others.
V3 very similar stiffness as V1

The laccase had no detrimental effects on the tortilla as long as levels were <83 LAMU/kg masa.

The characteristics of tortillas with laccase seemed closer to tortillas with CMC than those without CMC.

### Example 2

### Industrial Scale Trials of Laccase as a Replacement for CMC in Corn Tortillas

Corn masa flour was used as the base. In order to ensure that the masa flour did not contain CMC a type of masa flour that is intended for home preparation of tortillas was used (GRUMA). This product is finely ground. Typically the industrial tortillarias use a masa that is a combination of coarse and fine grind. The CMC was provided by GRUMA. Enzymes used:
Laccase, Flavourstar;830 LAMU/g
Gluzyme Mono 10,000 BG; A glucose oxidase.
Celluclast BG, which is a cellulose also having hemicellulase activities.

The general process followed is as follows: Approximately 28.5 liters of water are added to a horizontal paddle mixer. When enzymes are used, they are added with the water. Twenty kilo's of masa are added to the water along with the guar and, in the case of the reference, the CMC. The dough is mixed for approximately 5 minutes, with scraping. More water (typically no more that 1.5 liters) is added at the discretion of the operator and the dough mixed for about 2 minutes more.

The dough is transferred to the feed hopper of a tortilla maker. The hopper consists of large paddles mounted on top of a large conveying screw. The dough is extruded into a sheet via a series of four smaller conveying screws. The dough is formed into tortillas via a rotary molder and dropped onto a tiered, traveling oven. After traveling the first lap, the tortillas are automatically flipped, baked on the other side, flipped again and baked one more time on the original side. They are then automatically deposited to a cooling belt. Total baking time is approximately 30 seconds.

Important properties of corn tortillas are their resistance after reheating, since this is often what happens. Tortillas not consumed freshly baked will be refrigerated and reheated a day or 2 later. Fresh resistance and reheated resistance is a major care-about and is the reason CMC is used in dry masa flour. Tortillas made from fresh nixtamal have better resistance than those made from dry (without CMC).

Resistance quality is determined by scrunching the tortilla by hand and placing it on a table to unfold. Tortillas that show no signs of cracking have good resistance.

Trial 1:
All variants contain 0.5% guar gum (supplied by GRUMA)

| Tortillas | CMC (%) | LAMU/kg Masa | H₂O (liter) |
|---|---|---|---|
| V1 (reference) | 0.25 | | 29.5 |
| V2 (neg. reference) | | | 29.5 |
| V3 | | 41.5 | 29.5 |
| V4 | | 83 | 29.5 |
| V5 | | 415 | 29.5 |

Dough and baked product according to Trial 1 was evaluated as shown below.

Evaluation of trial 1

| | |
|---|---|
| V1 | Dough processed well. Slightly sticky. Good quality tor- |
| | tilla; nicely stretchy, slightly spongy. Good resistance |
| V2 | Stickier dough than V1. Not as spongy or stretchy as V1. |
| | Slightly drier texture. Not nearly as resistant tortilla |
| V3 | Stiff, somewhat hard dough at first, mellowed out some- |
| | what. Less sticky than V1. Tortillas not as stretchy as V1, but bet- |
| | ter than V2 |
| V4 | Firmer, less sticky dough than V3. Stronger but slightly |
| | thick tortillas. Dough probably could have used 0.5 L more H₂O. |
| | Better than V3, getting close to V1. |
| V5 | Softer dough than V4. Sticky at first but got better with |
| | handling. Although the dough was sticky in the feed hopper, it went |
| | through the former well. Very resistant tortilla; better than V1 |

Trial 2:
0.5% guar was used in all variants

| Tortillas | CMC (%) | LAMU/kg | GODU/kg | EGU/kg | H₂O (liter) |
|---|---|---|---|---|---|
| V1 (reference) | 0.25 | | | | 28.5 |
| V2 | | 208 | | | 29.5 |
| V3 | | 208 | 500 | | 29.0 |
| V4 | | 208 | | 350 | 30.5 |

GODU: glucose oxidase units; EGU: endo glucanase units.

Evaluation of trial 2

| | |
|---|---|
| V1 | Firm dough, not sticky. Good processing. Tortillas had good |
| | flexibility and resistance, nicely springy and stretchy |
| V2 | Softer dough (a plus - less work for the machine). Processed |
| | easier than V1. Tortillas had good resistance |
| V3 | Dough OK, slightly tackier than V2. Made a worse tortilla than |
| | V2; when properly baked it was not as resistant. |
| V4 | Dough needed 2 minutes additional mixing. Relatively soft dough |
| | at first but got significantly firmer towards the end of the |
| | batch. Dough handled well, but extra water could not be fully |
| | driven off without burning the tortillas. |

Evaluation of tortillas from Trial 1 after 2 days of refrigeration

Trial 1:
All variants contain 0.5% guar gum (supplied by GRUMA)

| Tortillas | CMC (%) | LAMU/kg Masa | H₂O (liter) |
|---|---|---|---|
| V1 (reference) | 0.25 | | 29.5 |
| V2 (neg. reference) | | | 29.5 |
| V3 | | 41.5 | 29.5 |
| V4 | | 83 | 29.5 |
| V5 | | 415 | 29.5 |

| | |
|---|---|
| | Warm evaluation: Tortillas were reheated in a warm |
| | skillet 15 seconds per side each side 2×. |
| V1 | Good fold-ability, OK rollability. Ok eating quality |
| V2 | Not much different than control |
| V3 | Seemed more moist than V1; best of the enzyme samples, |
| | similar to V1 |
| V4 | Very good fold-ability. Good eating quality |
| V5 | Good flexibility, somewhat rubbery |
| | Cold evaluation |
| V3, V4 | Feel as if they have more substance, more continuous. |
| | Wiggled in a more fluid motion |
| V5 | Feels very rubbery |

Color of the tortilla gets darker with increasing laccase dosage. Tortillas are less bright, increased tanning, slight grey cast. 40-80 LAMU are still acceptable in this respect.

Based on the darkening effect with increased dosage, 40-80 LAMU/kg masa was chosen as optimal dosage for further evaluation.

Trial 3:
All variants contained 0.5% guar

| Tortilla | CMC (%) | LAMU/kg | EGU/kg | H₂O (liter) |
|---|---|---|---|---|
| V1 | 0.25 | | | 28 |
| V2 | | 41.5 | | 28 |
| V3 | | 83 | | 28 |
| V4 (19 kg batch) | | 41.5 | 87.5 | 27 |

### Evaluation of Trial 3

| | |
|---|---|
| V1 | Firm, somewhat sticky dough. A bit too firm for optimum |
| | processing, but ran well none the less. Tortilla had |
| | good resistance and flexibility |
| V2 | About as firm as V1, but not sticky at all. Flows nice- |
| | ly through the hopper, much better than V1. Tortillas |
| | had nice resistance |
| V3 | Softer dough, but tackier than V2. With 2 minutes addi- |
| | tional mixing the dough lost the tackiness. Not nearly |
| | as good machinability as V2 - had too push the dough |
| | through the hopper; perhaps a bit too much H₂O. Machine |
| | was working against the dough, actually caused over- |
| | mixing in the hopper, causing it to become sticky during |
| | extrusion. Tortillas had good resistance, but not as |
| | good as V2 |
| V4 | Soft dough, slightly tackier than V3, but flows nicely |
| | through the hopper. Most resistant tortilla, much more |
| | so than V2, better than reference. |

Evaluation of tortillas produced in Trial 3 after 10 days of refrigerated storage:

### Procedure:

Tortillas packed in plastic bag the same night of making. Refrigerated 10 days
Heated in iron hot plate, 4 times (15 seconds each side). Two tortillas from each sample
Hot tortilla cooled out for 30 seconds and filled with typical type of juicy food to make a traditional taco and check “wet” resistance
Wet resistance rating: 4=outstanding, 3=very good, 2=good, 1=acceptable

| | Cold evaluation | |
|---|---|---|
| V1 | Lies flat; a bit stiff but still flexible, good body | |
| V2 | Wavy edges, less body than V1; drier and stiffer than V1 but | |
| | kind of rubbery at the same time | |
| V3 | Lies flat; good body; less dry and stiff than V2 | |
| V4 | Lies flat; good body; better flexibility than V1 | |
| | | Wet resis- |
| | Hot evaluation | tance rating |
| V1 | Does not break when folded in half; good roll- | 4 |
| | ability, smooth edges; | |
| V2 | One tortilla had slight breakage when folded, | 1 |
| | the other was OK. Good rollability, smooth edges. | |
| | Only fair wet resistance (but still acceptable) | |
| V3 | Slight breakage when folded in half. Good roll- | 2 |
| | ability with smooth edges; made a softer taco | |
| V4 | Did not break when folded in half. Good roll- | 3.5 |
| | ability; taco was a bit stiff. Very good wet | |
| | resistance. Close to reference. | |

From the above trials it is evident that laccase is a suitable alternative to CMC in tortillas made from dried masa flour and also that the further addition of hemicellulase, like e.g. Cellucast, on top of the laccase seems to improve the resistance.

1. A method of preparing a baked product from dried masa flour, wherein an enzyme capable of polymerizing polyphenolics is added to the dough.

2. The method according to claim 1, wherein the enzyme is selected from the group consisting of laccase (EC 1.10.3.2), catechol oxidase (EC 1.10.3.1), rifamycin-B oxidase (EC 1.10.3.6), peroxidise (EC 1.11.1.7).

3. The method according to claim 1, wherein no hydrocolloid is added.

4. The method according to claim 3, wherein the hydrocolloid comprises CMC and guar gum.

5. The method according to claim 1, wherein the dough is a non-leavened dough.

6. The method according to claim 1, wherein a hemicellulase is also added.

7. The method according to claim 1, wherein the enzyme is a laccase added in an amount of 10-500 LAMU/kg masa flour.

8. The method according to claim 1, wherein the baked product is a tortilla.

9. The method according to claim 1, wherein the laccase is a microbial laccase.

10. (canceled)

11. (canceled)

12. (canceled)

13. The method according to claim 8, wherein the tortilla is subsequently fried.

14. (canceled)

15. (canceled)

16. (canceled)

17. A corn tortilla obtained by the method according to claim 1.

18. The method according to claim 1, wherein the enzyme is a laccase (EC 1.10.3.2).

19. The method according to claim 1, wherein the enzyme is a catechol oxidase (EC 1.10.3.1).

20. The method according to claim 1, wherein the enzyme is a rifamycin-B oxidase (EC 1.10.3.6).

21. The method according to claim 1, wherein the enzyme is a peroxidise (EC 1.11.1.7).

22. The method according to claim 1, wherein the enzyme is a laccase added in an amount of 20-200 LAMU/kg masa flour.

23. The method according to claim 1, wherein the enzyme is a laccase added in an amount of 30-100 LAMU/kg masa flour.
